(19) United States
(12) Patent Application Publication
(10) Pub. No.: US 2009/0227251 A1
(43) Pub. Date: Sep. 10, 2009

(54) SYSTEM AND METHOD FOR AUTOMATICALLY MONITORING AND MANAGING WIRELESS NETWORK PERFORMANCE

(75) Inventors: Bo Lei, Shanghai (CN); Youqian Xiao, Shanghai (CN); Zheng Zhao, Shanghai (CN); Bo Liu, Shanghai (CN); Ou Jin, Shanghai (CN)

Correspondence Address: BRINKS HOFER GILSON & LIONE, P.O. BOX 10395, CHICAGO, IL, 60610, US

(73) Assignee: HUAWEI TECHNOLOGIES CO., INC., Shenzhen (CN)

(21) Appl. No.: 12/042,429

(22) Filed: Mar. 5, 2008

(51) Int. Cl. H04Q 7/20

(52) U.S. Cl. 455/425

(57) ABSTRACT

A system for automatically monitoring and managing network performance. The system comprises a mobile phone, adapted to have a monitoring function for providing monitoring information and communications regarding monitoring and management of network performance; and a mobile communication network, providing mobile communication services to the mobile phone. The mobile communication network comprises a Mobile Measurement Agent (MMA), adapted to control performing of the monitoring function of the mobile phone, and to communicate with the mobile phone; a data server, adapted to store information comprising the monitoring information; and a component for processing the information stored in the data server, wherein a processing result of the information is used in performance monitoring and management of the mobile communication network.

### CROSS-REFERENCE TO RELATED APPLICATIONS

Not applicable.

### TECHNICAL FIELD OF THE INVENTION

The present invention relates generally to telecommunications, and more particularly, to a versatile system for automatically monitoring and managing wireless network performance.

### BACKGROUND OF THE INVENTION

With rapid development of and increased competition in mobile communication services, user expectations for the quality of mobile communication networks increase. How to provide high quality network environment to the satisfaction of users is becoming one of the main purposes for network maintenance and optimization.

Moreover, because of the increasing number of functions performed by a mobile phone, and increasing varieties of services provided by operators, types of services running within a mobile network increase dramatically. Operators' attention with respect to network operation and maintenance has been changed from traditional network performance to service perception performance, i.e., satisfaction of users' experience of various services need to be guaranteed, in addition to network performance.

Conventional methods for testing network quality include Key Performance Indicator (KPI) statistics, customer complaint, non-periodic network assessment (driving test), and automatic driving test. However, each of these conventional methods has its own limitations.

The KPI statistics may be used to generate KPI parameters of a whole network during a given period of time. But this method is limited on problem analysis and determination, and unable to reflect users' real experience of service (EoS).

Customer complaint is a typical method used for monitoring Quality of Service (QoS), however, few users may respond with complaints for unsatisfactory network services until situations become unbearable. Furthermore, using this method, nothing may be done to improve network performance until complaints are received, and thus at this point, problems may be found but not solved.

Non-periodic driving test may be used to monitor network quality by non-periodically testing network services within a predetermined area and during a predetermined period of time. However, testing results using this method may not reflect quality of a whole network since the test does not cover the whole network. Moreover, performing a non-periodic driving test may place a high demand for manpower and resources, and may be limited by various natural conditions. Therefore, this method is costly and insufficient.

In an automatic driving test, an automatic driving test system installed on a transport or in some place may be used to simulate network services, monitor and test network performance. This method may significantly increase space and time within which network data are collected, save manpower, improve efficiency for monitoring network performance, and provide monitoring of network performance in real-time to a certain extent. However, results from an automatic driving test may not be able to represent situations of a whole network.

Referring to the Prior art of FIG. 1, a diagram 100 illustrates an example of a conventional system for automatic driving test. A control unit 102 sends a testing command through a Base Station 104 to a Mobile Testing Unit (MTU) 106, which may be installed in a cab or another transportation vehicle. The MTU 106 performs the driving test, records testing data, and periodically or instantly sends the testing data to the control unit 102. The testing data may be stored in a database server 108 via an access unit 110. The control unit 102 may obtain the testing data, instruct an analysis unit 112 to perform statistical analysis, and generate various reports. Thus, through mobility of the transportation vehicles within a network, collection of network data and monitoring of network performance may be performed automatically.

Although an automatic driving test is more efficient than a conventional driving test, it still lacks flexibility and portability, for a testing unit may only be installed in a transportation vehicle. Testing routes in an automatic driving test are limited, and therefore testing results may not represent quality of services of a whole network. Furthermore, the testing may not represent real usage of network services, and may not provide evaluation of EoS. In addition, no complaint may be made to the “network quality” problems caused by mobile phones. This method may be used mainly to measure and monitor network quality, lacking capabilities in problem identification and comprehensive analysis.

Conventional systems for evaluating QoS and EoS of users are basically separate and independent network performance testing systems. An additional testing unit may be plugged in a network, and evaluation of EoS may be performed by simulating services provided to actual users. Methods for evaluating EoS may calculate various performance indicators of active services, for example, time delay, success rate, etc. of various services, such as Wireless Application Protocol (WAP) services, WEB services, or Multimedia Message Services (MMSs). For audio or video services, methods for evaluating EoS may simulate users' experience of various services, which may be done using methods known as “with reference” evaluation. A “with reference” method may compare a received file with an original file, and produce Mean Opinion Scores (MOSs) of simulated user experiences. One example of such methods is the method for Perceived Evaluation of Speech Quality (PESQ).

The above methods have disadvantages, though they may support testing of users' EoS. In these methods, additional units for testing QoS are needed in a network, complicating network performance management system. The methods also use simulated services, instead of real-time network services, to evaluate the QoS, and therefore may not represent situations of a real network. Further, performance data available from the network side is not used by the testing system, and therefore, these methods may not provide effective analysis in case of poor QoS.

Therefore, conventional methods for monitoring network performance may not meet the goal of current trend in network maintenance and optimization, as described previously. Thus, there is a need for a comprehensive and integrated system that provides automatic monitoring, management and optimization of network performance and quality of services.

### SUMMARY OF THE INVENTION

A system for automatically monitoring and managing network performance is provided. The system comprises a mobile phone, adapted to have a monitoring function for providing monitoring information and communications regarding monitoring and management of network performance; and a mobile communication network, providing mobile communication services to the mobile phone. The mobile communication network comprises a Mobile Measurement Agent (MMA), adapted to control performing of the monitoring function of the mobile phone, and to communicate with the mobile phone; a data server, adapted to store information comprising the monitoring information; and a component for processing the information stored in the data server, wherein a processing result of the information is used in performance monitoring and management of the mobile communication network.

The following description and drawings set forth in detail a number of illustrative embodiments of the invention. These embodiments are indicative of but a few of the various ways in which the present invention may be utilized.

### BRIEF DESCRIPTION OF THE SEVERAL VIEWS OF THE DRAWINGS

For a more complete understanding of the present disclosure and its advantages, reference is now made to the following description taken in conjunction with the accompanying drawings, in which like reference numerals represent like parts:

FIG. 1 depicts an example of an automatic driving test system;

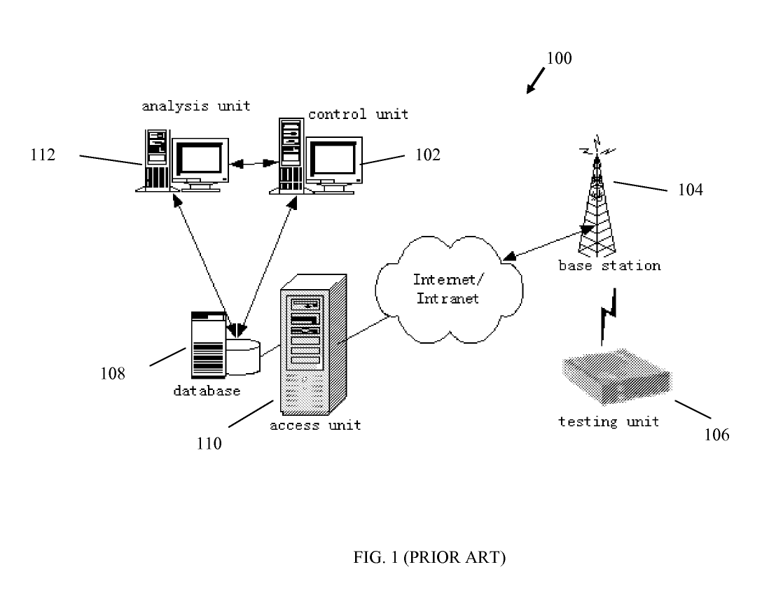

FIG. 2 depicts an overall structure of a system for wireless network performance monitoring and management according to one embodiment of the present invention;

FIG. 3 depicts functional structures of a mobile phone according to one embodiment of the present invention;

FIG. 4 depicts functional structures on the network side according to one embodiment of the present invention;

FIG. 5 depicts files to be uploaded to an MMA server according to one embodiment of the present invention;

FIG. 6 depicts data provided by mobile phones and stored on a data server according to one embodiment of the present invention;

FIG. 7 depicts data provided by network elements that is stored on a data server according to one embodiment of the present invention;

FIG. 8 depicts a block diagram for processing information stored in a data server according to one embodiment of the present invention;

FIG. 9 depicts a user interface for measurement configuration according to one embodiment of the present invention; and

FIG. 10 depicts a user interface for measurement configuration according to one embodiment of the present invention.

### DETAILED DESCRIPTION OF THE INVENTION

The following discussion is presented to enable a person skilled in the art to make and use the invention. The general principles described herein may be applied to embodiments and applications other than those detailed below without departing from the spirit and scope of the present invention as defined herein. The present invention is not intended to be limited to the embodiments shown, but is to be accorded the widest scope consistent with the principles and features disclosed herein.

The present invention provides a system, comprising various constructs and methods, for automatically monitoring and managing wireless network performance. Embodiments in the present invention may provide automatic and comprehensive monitoring and management of network performance, by use of mobile phones with extended functions within real communication networks, and combining Call History Records (CHRs) available on network side.

For example, the system in embodiments of the present invention may provide monitoring of wireless environments, such as, network coverage and signal quality, etc., using location information of mobile phones; provide direct evaluation of users' real experience of services; provide monitoring and recording of mobile phone procedures in idle mode; and provide recording of abnormal and key events of mobile phones, and pre- and post-messages around events of mobile phones. Mobile phones in the system of the embodiments of the present invention may be extended to have one or more monitoring functions with respect to monitoring and management of network performance. By utilizing information provided through the monitoring functions on mobile phone side, and CHRs on network side, the system in the embodiments of the present invention performs comprehensive end-to-end analysis, analyzing and defining problems, and providing automatic and comprehensive monitoring, management and optimization of network performance, including users' experience of services.

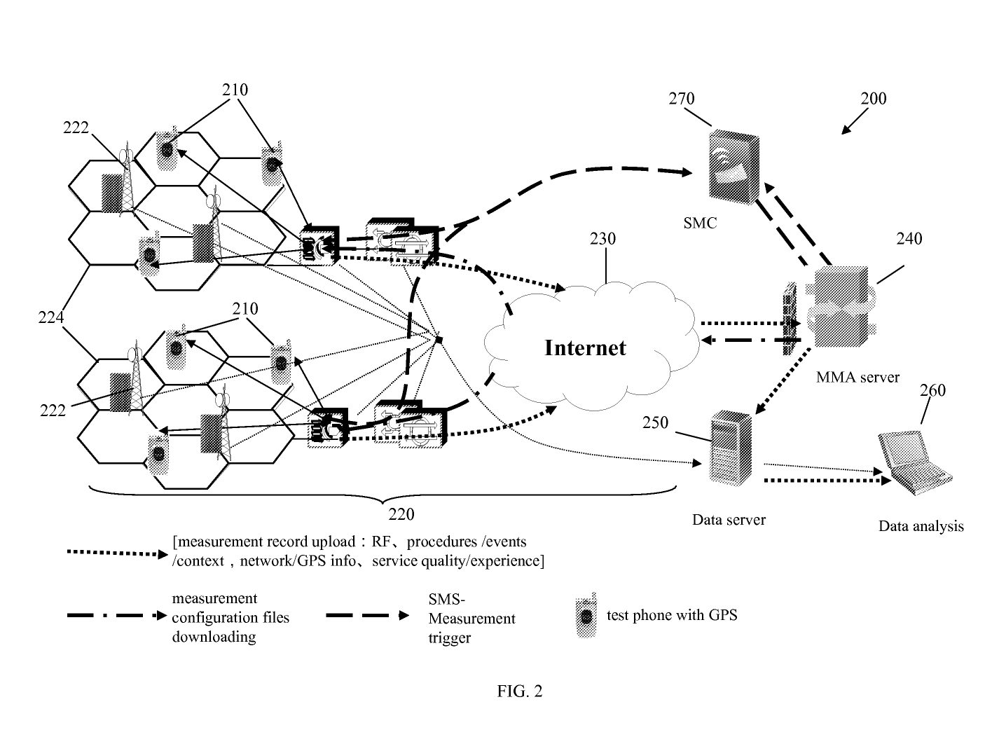

FIG. 2 illustrates an embodiment of an overall structure 200 of a system for automatically monitoring and managing network performance of a mobile communication network according to the present invention.

The system in FIG. 2 includes a plurality of mobile phones 210 within a mobile communication network 220. The network 220 includes a plurality of Base Stations (BSs) 222 covering certain areas 224 within which mobile communication services are provided to the mobile phones 210. The mobile phones 210 may be commercial mobile phones, and adapted to provide one or more monitoring functions.

The monitoring functions may provide capabilities for the mobile phones 210 to obtain, including measure or collect, monitoring information; to communicate with a destined entity regarding the monitoring and managing of network performance of the network 220, e.g., a mobile phone may report certain monitoring information to the network 220; or to perform any other functions for the purpose of monitoring and managing network performance, without departing the scope and spirit of the present invention.

The monitoring information that may be obtained by the mobile phones 210 may include information that is useful in or related to monitoring and managing network performance of the network 220. For instance, the monitoring information may include wireless signal measurement information; network information; location information; key procedures, key events and pre- and post-messages around events on mobile phone side; or Quality of Service (QoS) and users' Experience of Service (EoS) on mobile phone side; etc. The monitoring functions and monitoring information will be described in details later. However, the monitoring functions and monitoring information that may be applied to the present invention are not limited to those described in the embodiments of the present invention.

The network 220 may trigger, as needed, one of the mobile phones 210 to perform one or more monitoring functions to “monitor” the network 220. In one example, the network 220 may trigger a mobile phone 210 to obtain particular monitoring information, such as problems with respect to quality of network or QoS; key events, such as call events, mobile phone's service events, or abnormal events of mobile phones which may not be available at network side; or pre- and post-messages around various events; etc. Alternatively, the mobile phone 210 may be triggered to perform a monitoring function according to a triggering condition, such as when a particular event of the mobile phone 210 occurs, or on a periodic base, such as every one hour or every 3 minutes. The mobile phone 210 may obtain and record in a particular manner the monitoring information, and transmit the monitoring information to a server on the network 220 under certain conditions.

The network 220 may provide an application server—Mobile Measurement Agent (MMA) 240, which may be adapted to control, via an Internet 230, the performing of the monitoring functions on mobile phones 210, and communicate with the mobile phones 210. In one embodiment, the MMA server may control when or how a monitoring function is performed, what monitoring functions may be performed, what monitoring information may need to be obtained by a mobile phone, or how or when the monitoring information is transmitted to the MMA, etc.

The MMA 240 may implement the control in various ways, e.g., by utilizing messages, such as short messages, or configuration information, such as a configuration file, regarding the performing of monitoring functions of the mobile phones 210. The MMA 240 may further receive the monitoring information from the mobile phones 210, and forward the information to a specific data server 250.

The data server 250 may store network elements CHR of an Access Network (AN) of the mobile communication network 220, in addition to the monitoring information from the mobile phones 210. Information on the data server 250 may be correlated using mobile phone IDs and callings, and processed by some data analysis tools 260 using network performance analysis software. The data processing may report problems about quality of network and services thereof, provide supplementary end-to-end problem analysis and identification, provide optimization advices using expert systems, and provide customized user interface and reports, etc.

The network 220 may also include a Short Message Center (SMC) 270, which may send short messages, under control of the MMA 240, to trigger the mobile phones 210 to start or stop monitoring functions.

The system in this embodiment may provide automatic, comprehensive, and real-time monitoring and management of network performance, which may be related to information including wireless signals, network and location information, idle mode processes, calling procedures, QoS, and internal abnormal events of mobile phones. Moreover, the system in the embodiment may make use of existing CHR information on network side, providing end-to-end analysis.

The system in this embodiment may be based on commercially used mobile phones, thus providing more flexibility in deployment and usage of the system, and may be applied to various networks, including CDMA2000; Universal Mobile Telecommunication System (UMTS), such as Wideband Code Division Multiplexing Access (WCDMA) and High-Speed Packet Access Plus (HSPA+); Enhanced Data rates for GSM Evolution (EDGE) networks; WiMAX; and 4G networks, such as a Long Term Evolution (LTE) 4G network, etc.

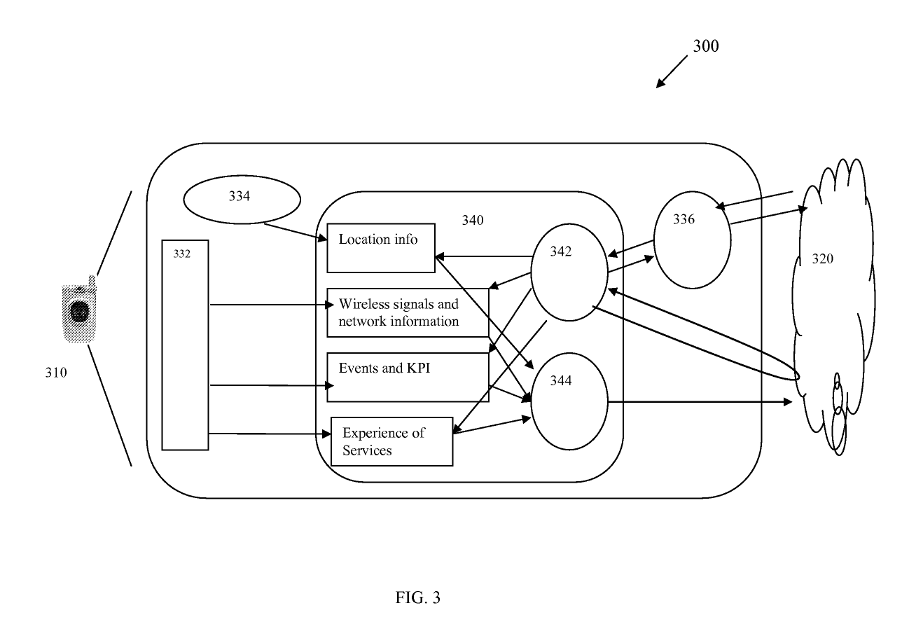

Referring to FIG. 3, a diagram 300 illustrating an embodiment of functional structures of a mobile phone in the system in FIG. 2 according to the present invention. A mobile phone 310 may include a component 332 to provide mobile phone information, and such information may include wireless quality, network information, data packets analysis, mobile phone signaling, various events, and evaluation of experience of services, etc. The component 332 may send the mobile phone information to a component 340 in the mobile phone 310. The component 340 in the mobile phone 310, as part of a Mobile Measurement Agent (MMA), may communicate with a network 320 for the monitoring and management of the network performance. The component 340 may include a control component 342 and a communication component 344. Monitoring of network performance by the mobile phone 310 may be controlled by the network 320 through short messages received via a short message component 336 in the mobile phone 310 or may be controlled by the network 320 through both short messages and measurement configuration files sent by the network 320. The measurement configuration files will be described later.

The mobile phone 310 in the system of the embodiments of the present invention may be a commercial mobile phone with extended monitoring functions for monitoring and managing network performance, e.g., a 3G commercial mobile phone with a plurality of monitoring functions. The mobile phone 310 may provide processing and storage capabilities to support the extended monitoring functions, and may further provide location information utilizing a Global Positioning System (GPS), such as utilizing a GPS chip 334 embedded in the mobile phone 310.

A. Monitoring Functions Extended on a Mobile Phone

As described earlier, the monitoring functions, that may be extended on a mobile phone in the embodiments of the present invention, may enable the mobile phone, such as the mobile phone 310, to obtain monitoring information regarding the monitoring and management of network performance, and to communicate with a specified entity. The monitoring functions and monitoring information that may be obtained are described in the following.

1. A mobile phone may obtain, e.g., collect and/or measure, monitoring information such as wireless signal measurement information, network information and location information. For example, in a Universal Mobile Telecommunication System (UMTS) network, information collected or measured by a mobile phone may include strength and quality of receiving signals in an active set or a monitor set; Signal-Interference Ratio (SIR), and Transport Channel Block Error Rate (TRCH BLER); transmitted and received power; and CELL ID, frequency, User Registration Area (URA) ID, and Global Positioning System (GPS) information; etc.

In one embodiment, the monitoring functions for collecting or measuring the above information may be implemented on a 3G commercial mobile phone, and GPS information may be provided by an embedded GPS chip in the mobile phone. The GPS information may alternatively be obtained by a mobile phone from an independent GPS equipment by way of Bluetooth.

To reduce workload of a mobile phone, monitoring functions to obtain monitoring information, e.g., to collect or measure the monitoring information, in embodiments of the present invention, may be performed on conditions. The conditions may be, for example, when a key event occurs, or when strength or quality of a signal is lower than a given threshold, etc. Alternatively, when workload is not a concern, the collection or measurement may be performed continuously and/or periodically. How to perform the collection or measurement may be configurable, and may be configured by a network of the mobile phone.

Table 1 shows an example of the wireless signal measurement information, network information and location information that may be collected or measured by a mobile phone.

TABLE 1

| Information | Description |
|---|---|
| IMSI | International Mobile Subscriber Identity |
| YY:MM:DD:HH:MM:SS:ms | Time record, millisecond precision |
| XXX.XXXXX | GPS longitude information |
| XXX.XXXXX | GPS latitude information |
| LAC | Location Area code |
| RAC | Routing Area code ID |
| CELL ID | Main serving cell. The lower 16-bit |
| | represents cell ID, and higher 16-bit |
| | represents Regional Node Center (RNC) |
| | ID. For example, for 0x30022, cell ID |
| | is 0x22, and RNC ID is 0x30. |
| UL Freq | Uplink frequency |
| DL Freq | Downlink frequency |
| Rx | Received power |
| Tx | Transmitted power |
| ACTIVE SET | |
| >P-SC | Primary scrambling codes |
| >Ec/Io | Pilot Ec/Io |
| >RSCP | Pilot RSCP |
| MONITOR SET | |
| >P-SC | |
| >Ec/Io | |
| >RSCP | |
| TRCH information | Valid on connection |
| >TRCH ID | Transport Channel ID |
| >BLER | BLER correspond to the TRCH |

2. A mobile phone may obtain monitoring information such as key procedures, key events, or pre- and post-messages around the events on mobile phone side. A mobile phone may obtain information of procedures and events when it is in an idle mode, and the procedures or events may include power-on, end of cell search, start and end of cell re-selection, paging receiving time and response time, starting and ending time of random access, number of attempts of random access, and inter-RAT (Radio Access Technology) handover, etc. These procedures or events in non-connection states, that are not observable on network side, may be obtained and recorded by a mobile phone, and provided to the network for analysis and optimization to improve network performance.

A mobile phone may also record key procedures or events on mobile phone side, including access failure, PDP activation failure, call drops, handover failures, and link release, etc; and pre- and post-messages around events, which may comprise 3˜5 pre- or post-messages, providing information for end-to-end analysis.

In addition, a mobile phone may record information of events about the mobile phone itself, such as lost network connection, no signal, battery exhaust, power-off, or system halted for software problems, etc. The information may help separate non-network factors in problem analysis and identification.

Other events, that may not be observable on network side, or that may be useful in network optimization or network problem analysis and identification, may also be obtained and/or recoded on a mobile phone by extending corresponding functions on the mobile phone.

Table 2 shows an example of the information that may be obtained and recorded on mobile phone side.

TABLE 2

| Information | Description |
|---|---|
| IMSI | International Mobile Subscriber |
| | Identity |
| YY:MM:DD:HH:MM:SS:ms | Event occurring time |
| Event ID | One of the events described above |
| YY:MM:DD:HH:MM:SS:ms | Event occurring time |
| Event ID | One of the events described above |
| . . . | |

3. A mobile phone may obtain monitoring information such as Quality of Service (QoS) and users' Experience of Service (EoS) on the mobile phone side. For operators of communication networks, Key Performance Indicators (KPIs) of networks may not represent the real Quality of Experience (QoE) of each service provided to a user. QoE is a very important factor for helping operators improve users' satisfaction of services. As the processing capability of mobile phones improving continuously, the real QoE of different services are expected to be measured objectively and directly on mobile phones.

A mobile phone may use some objective measurement algorithms to measure users' experience of various services. In these objective measurement algorithms, factors that may affect users' experience of each service may be identified and listed. The factors may include indicators such as success rates, time delays, jitters, number and time of buffering, and download rates, etc; and may include network factors that may affect the indicators previously described, such as block error rates, packet-loss rates, and average service rates, etc. These factors may be used to obtain Mean Opinion Scores (MOSs) which represent users' EoS, through simulation, fitting and formula conversion.

The objective measurement algorithms may be referred to as objective evaluation algorithms without references, such as algorithm P.563 or E-MODEL for evaluating experiences of speech quality. These algorithms may also be applied to evaluate QoE of services such as video phone, video streaming on-demand, webpage navigation, FTP download, etc. The users' experiences may be decomposed into a series of indicators that are measurable and representative of quality of the services, and a series of network indicators including wireless indicators. The resulted indicators may then be fitted through mathematical modeling, resulting in formulae for evaluating the users' EoS.

A mobile phone may measure and record the indicators described above during processes of services, and obtain measurement of users' EoS utilizing particular formulae. One embodiment of the evaluation records of QoS and EoS is illustrated in Table 3.

TABLE 3

| Information | Description |
|---|---|
| IMSI | International Mobile Subscriber |
| | Identity |
| ServiceType ID | |
| YY:MM:DD:HH:MM:SS:ms | Service starting time |
| YY:MM:DD:HH:MM:SS:ms | Service ending time |
| MOS | Overall evaluation of the service |
| -BLER | Decomposed indicator 1: average |
| | BLER (for example) |
| - . . . | Decomposed indicator 2: |
| - . . . | . . . |

4. Communication between mobile phones and networks and control thereof are described in the following. A mobile phone may be provided monitoring functions to communicate with its networks, such as receiving control from network side, uploading information to a network, or downloading data from a network. Details of the communication and control will be described later.

In one embodiment, a mobile phone may be able to identify short messages sent from a Service Provider (SP) with a particular SP number, interpret the short messages, initiate or terminate measurements of monitoring information, and update measurement configuration files according to the short messages.

A mobile phone may be able to download measurement configuration files from an MMA server on network side according to instructed address, interpret content of the measurement configuration files, and perform monitoring functions according to the interpretation. Moreover, a mobile phone may be able to initiate uploading of obtained monitoring information to a data server under prescribed conditions according to the measurement configuration files. A mobile phone may also be able to compress data to be uploaded following a particular algorithm.

The monitoring functions that may be provided on a mobile phone in the embodiments of the present invention may be implemented by integrating with software already available on the mobile phone, and no additional software application is needed to be developed and installed.

B. Network Side

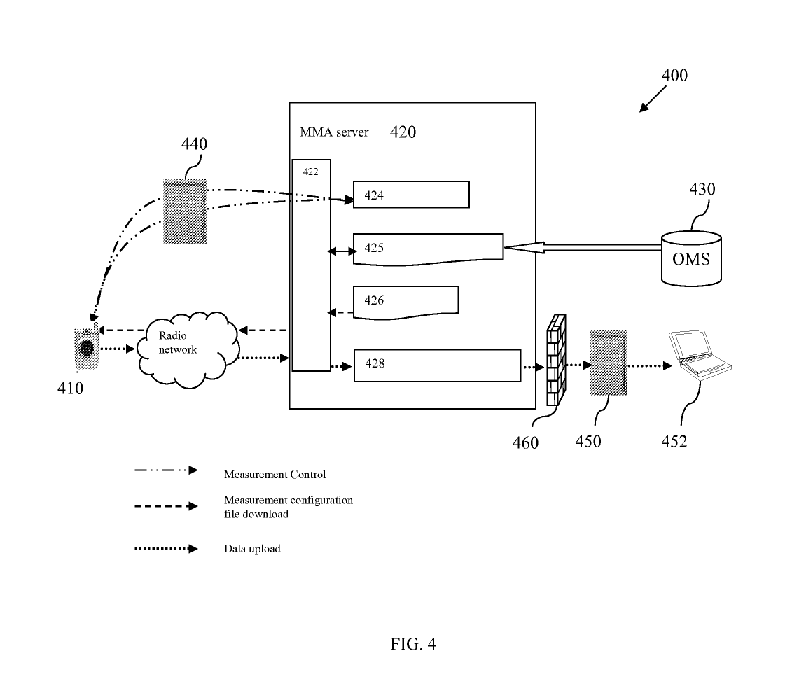

A network in the embodiments of the present invention may provide support of monitoring functions on mobile phone side, uploading, storage and analysis of the obtained monitoring information on mobile phone side. FIG. 4 illustrates an embodiment of configurations of a network 400 for the system in the embodiments of the present invention, such as the network in FIG. 2.

A mobile phone 410 receives services from the network 400, and may be provided with monitoring functions described in FIG. 2 and/or FIG. 3. The network 400 in FIG. 4 may include an MMA server 420, which may be an independent computer, or an application on a physical server together with other applications.

The MMA server 420 may include a safety control component 422, a measurement control component 424, and a data collection component 428. The MMA server 420 may also provide a measurement configuration file 426.

The network 400 may have various configurations and functions. The network 400 may include an Operation Maintain System (OMS) 430, which may have a list of IDs of mobile phones with monitoring functions described in the embodiments of the present invention, and may have general knowledge of areas where the mobile phones move, as bases for initiating monitoring of network performance. The mobile phone IDs may include mobile phone numbers and/or IMSI. The OMS 430 may send a list of mobile phone IDs 425 to the MMA server 420, and mobile phones with the IDs may be triggered by the MMA server 420 to start correspondent monitoring functions.

The MMA server 420 may have a fixed IP address pre-assigned by operators, and the mobile phone 410 may access the MMA server 420 via Internet or FTP.

For control of monitoring functions on mobile phone side, the MMA server 420 may be set as a specific Service Provider (SP), e.g., “1900”. The SP may be used specifically for transmitting short messages via a short message center 440 to the mobile phone 410, triggering the mobile phone 410 to initiate or terminate monitoring, or updating a measurement configuration file. The mobile phone 410 may interpret short messages received from a specific SP accordingly, which will be described later.

The MMA server 420 may record IDs of certain mobile phones that have initiated monitoring successfully, and use the component 422 to authenticate mobile phones that may need further uploading from or downloading to the MMA server 420, preventing unauthorized access to the MMA server 420.

The MMA server 420 may be configured to provide downloading services. The measurement configuration file 426 may be downloaded for providing configurations of measurement and uploading to be performed by the mobile phone 410. The measurement configuration file 426 may be changed manually, and the mobile phone 410 may be notified about the change through short messages.

The MMA server 420 may also be configured to be an FTP server, or any other application server which is in correspondence with required uploading format, for receiving uploading from the mobile phone 410, and storing uploaded data in a particular manner. For example, the uploaded data may be stored according to mobile phone IDs and uploading time, as shown in Table 4.

TABLE 4

| | | | Uploading |
|---|---|---|---|
| Mobile phone ID | Uploading time 1 | Uploading time 2 | time 3 |
| Mobile phone ID 1 | Uploading file 1 | Uploading file 2 | . . . |
| Mobile phone ID 2 | Uploading file 1 | Uploading file 2 | . . . |
| . . . | . . . | . . . | . . . |

The network 400 may include an additional independent data server 450. The mobile phone 410 may not access the data server 450 directly, but data from the mobile phone may be uploaded to the MMA server 420, and forwarded to the data server 450 for storage. The data server 450 may also store data obtained by other network elements of the network 400 and CHR information, or may further include a “network problem expert system”. The MMA server 420 may be separated with the data server 450 by a fire wall 460.

The data collection component 428 may support compression and decompression of data uploaded from the mobile phone 410. The data server 450 may be connected with data analysis tools 452, for processing comprehensively data on the independent data server 450. The data processing will be described later.

C. Monitoring Control and Data Uploading

Referring still to FIG. 4, one embodiment for triggering the mobile phone 410 to start monitoring functions is to set up the MMA server 420 as an SP unit. The SP unit may be configured the same as normal SPs, that is, an SP code and service code, such as “1900” are assigned to the SP unit, and management of the SP unit may be provided in the Internet Short Message Gateway (ISMG) of the network 400. Communication between the SP unit and the IMSG follows the Short Message Service (SMS) Protocol, and the message content may be customized. Table 5 illustrates an embodiment of a network control short message for controlling monitoring functions of a mobile phone.

TABLE 5

| Message Content | Description | Note |
|---|---|---|
| XXXXXXXXXXXXXX | Server address for downloading | IP address + port number |
| | measurement configuration file | |
| XXXXXXX | Measurement configuration file name | TXT file name |
| XXXXXXXXXX . . . | Message content, a series of digits | |
| | (0~1), | |
| >1^{st} bit | 0: start monitoring/1: stop | Invalid for any other digits |
| | monitoring | |
| >2^{nd} bit | 0: upload immediately | Whether upload |
| | | immediately |
| >3rd bit | 0: update measurement configuration | Configuration file update |
| | file | indicator |
| . . . | . . . | . . . |

As illustrated in Table 5, content of such a short message may include: server address for downloading and/or uploading; measurement configuration file name; a series of digits, where the first bit represents starting or stopping monitoring, the second bit represents whether upload will be performed immediately, and the third bit represents a new measurement configuration file is needed to be downloaded. The other bits may be defined as needed.

Thus, the MMA server 420 may send short messages to particular mobile phones the same way as other normal SPs. The mobile phones may take actions accordingly upon receiving the short messages, and respond to the MMA server 420 whether actions are successful, e.g., by sending a short message to the MMA server 420. Table 6 illustrates an embodiment of a message sent by a mobile phone in response to the control of an MMA server. If no response is received within a designated period of time from the mobile phones, the network may need to resend the short messages.

TABLE 6

| Message | | |
|---|---|---|
| Content | Description | Note |
| XXXXXXX . . . | Message content, a series of digits (0~1), | Indicators for response; each |
| | | bit represents response to a |
| | | control item in a network |
| | | control short message. |
| >1^{st} bit | Response to control for starting | 0 represents success, and 1 |
| | monitoring or stopping monitoring | failure |
| >2^{nd} bit | Response to control for immediate | |
| | uploading | |
| >3rd bit | Response to control for updating | |
| | measurement configuration file | |
| . . . | . . . | . . . |

D. Measurement Configuration File Format and Content

As described above, a network control short message sent by an MMA server to a mobile phone may include an IP address of the MMA server. When the mobile phone is instructed by the network control short message to start monitoring or update the measurement configuration file, the mobile phone may download the measurement configuration file according to the IP address and configuration file name, and interpret the measurement configuration file.

A measurement configuration file provides configuration information for a mobile phone to perform monitoring functions. In one embodiment, a measurement configuration file may indicate information items to be obtained, e.g., measured or collect, by a mobile phone. The measurement configuration file may further indicate whether measurement or collection of certain items may be performed periodically; and if there is no such indication, the measurement or collection may be triggered by events.

The events herein may include not only the various events described in the embodiments of the present invention, but also some “conditional events”, such as poor coverage, strong interference, poor speech quality, etc. Events may be user-defined and configurable, e.g., an event may be configured on network side through a measurement configuration file as needed.

A measurement configuration file may indicate that the obtained information may be uploaded on conditions. For example, the information may be uploaded periodically; or when the information data size exceeds a give threshold, or exceeds a certain percentage of capacity of a mobile phone memory.

The measurement configuration file may be in a TXT format, and a mobile phone downloading the measurement configuration file may be adapted to be able to interpret it. Table 7 illustrates an embodiment of a measurement configuration file in a TXT format.

TABLE 7

| File Content | Description | Note |
|---|---|---|
| XXXXXXXXXX . . . | Text content and series of digits(0~9), | Each bit |
| >1^{st} bit | Whether wireless signal and location | represents a |
| | information is measured periodically; | control item, |
| | 0: yes, 1: no | which may be |
| >2^{nd} bit | period | customized |
| >>{0~9} | 1 sec/5 sec/10 sec/20 sec/30 sec/40 sec/ | |
| | 60 sec . . . | |
| >3^{rd} bit | Conditions to trigger upload | |
| >>>{0~3} | 0~3 represent, respectively, upload | |
| | periodically/upload based on file size/ | |
| | upload based on percentage of file size | |
| | to memory space | |
| >4^{th} bit | Different values for different | |
| | triggering conditions | |
| >>{0~9} | Represent respectively: 1 min/5 min/15 min/ | |
| | 30 min/60 min/2 hr/ . . . | |
| | 300 KB/500 KB/1000 KB/2000 KB/ | |
| | 4000 KB/ . . . | |
| | 15%/30%/50%/75% . . . | |
| >5^{th} bit {0, 1} | Rx measurement indicator | 0 represents |
| >6^{th} bit {0, 1} | Tx measurement indicator | no |
| >7^{th} bit {0, 1} | SIR measurement indicator | measurement |
| >8^{th} bit {0, 1} | Active set measurement indicator | and uploading |
| >9^{th} bit {0, 1} | Monitor set measurement indicator | are initiated; |
| >10^{th} bit~13^{th} bit | Active set and monitor set | and 1 |
| {0, 1} | measurement indicator | represents |
| >14^{th} bit~15^{th} bit | Transport channel measurement | initiating |
| {0, 1} | indicator | measurement |
| >16^{th} bit~23^{rd} bit | Network information measurement | and uploading. |
| {0, 1} | indicator | The definition |
| >. . . | Quality of services measurement | may be |
| | indicator | customized. |
| >. . . | Key events measurement indicator | |
| >X bit | Definition of poor coverage event, | Other events |
| | lower than a RSCP value. | definition |
| >>{0~9} | −85 dbm, −90 dbm, −100 dbm, −110 dbm, −120 | |
| | dbm . . . | |
| . . . | Other events | |
| . . . | . . . | |

E. Downloading and Uploading Between Mobile Phones and MMA

As described previously, an MMA server may be configured to support uploading and downloading of data. In one embodiment, an MMA server may be configured as a virtual HTTP server for downloading, and an FTP server for uploading. Alternatively, the MMA server may be an FTP for both uploading and downloading. Configuring the MMA as a server may be accomplished via software, where fixed IP address and port number are assigned, and correspondent serving and listening processes of the port are initiated, for processing requests received from end users to the port. Once the server is set up, socket of the MMA server is ready for providing services.

Mobile phones may perform uploading following general FTP processes, such as defining ftp uploading functions, based on socket functions provided by an operating system or developing platform. When an uploading condition is met, a mobile phone may invoke the ftp uploading functions to perform data uploading. A general socket process may include the following steps:

a. Creating socket connection, such as using Socket clientSocket=new Socket (HOSTNAME, LISTENPORT), where the variables represent the server's name and port number, respectively;

b. Obtaining read and write streams of the created socket, such as using functions getInputStream ( ) and getOutStream ( );

c. Performing read and write (download/upload) using the streams;

d. Closing the streams; and

e. Closing the socket.

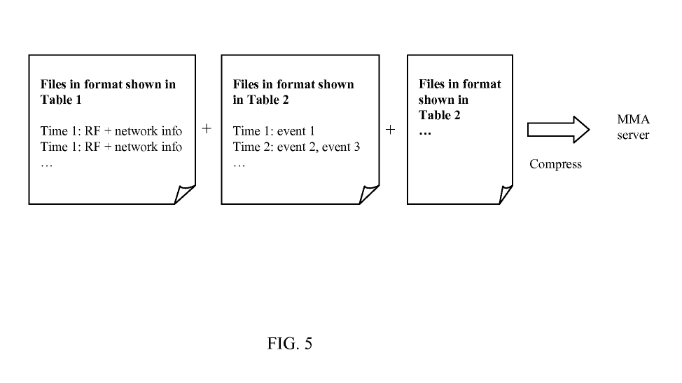

The monitoring information obtained on mobile phone side may be recorded as files using various formats, e.g., the format in Table 1, 2 and 3. When conditions required in a measurement configuration file are met for uploading a recorded file, a mobile phone may upload the related file to an MMA server. The files to be uploaded may be in a text or binary format. FIG. 5 illustrates an embodiment of files to be uploaded to an MMA server. Raw monitoring data may be compressed on mobile phone side before uploading to save transmission resources, and an MMA server receiving the data may decompress the data accordingly.

F. Charging Processing

Since the embodiments in the present invention may use mobile phones of some real friendly users for monitoring and managing network performance, communications, such as short messages transmission, or file uploading, from a mobile phone related to such monitoring and management should not be charged by the core network.

In one embodiment, this may be implemented utilizing the core network and corresponding service charging units. For instance, functions may be provided on a service charging unit for identifying mobile phone IDs and service types. That is, mobile phone IDs may be identified for those mobile phones that have successfully initiated functions for monitoring and managing network performance. Then communications of those identified mobile phones with particular MMA servers regarding monitoring and managing of network performance will not be charged, which may include performing of certain monitoring functions, messaging with a special SP on an MMA server as described in the embodiments of the present invention, and downloading or uploading services with respect to such MMA server.

G. Data Processing

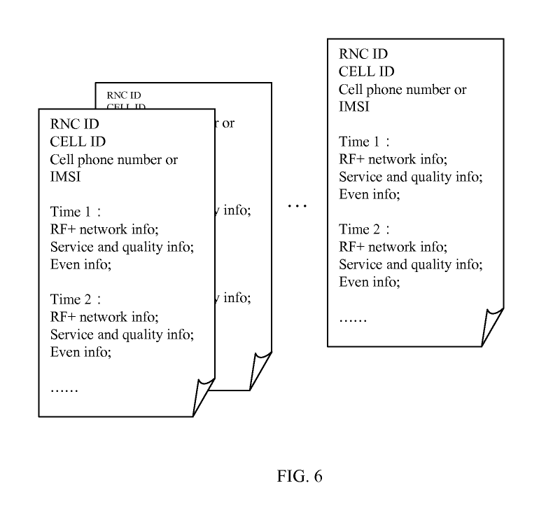

Data uploaded by mobile phones on an MMA server in the embodiments of the present invention may be decompressed on the MMA server and forwarded to an independent data server periodically. The data server may re-organize data uploaded aperiodically from mobile phones, preparing for correlation processing with data available on network side, or organize and store the data in a manner convenient for data processing. FIG. 6 illustrates an embodiment of data provided by mobile phones and stored on a data server.

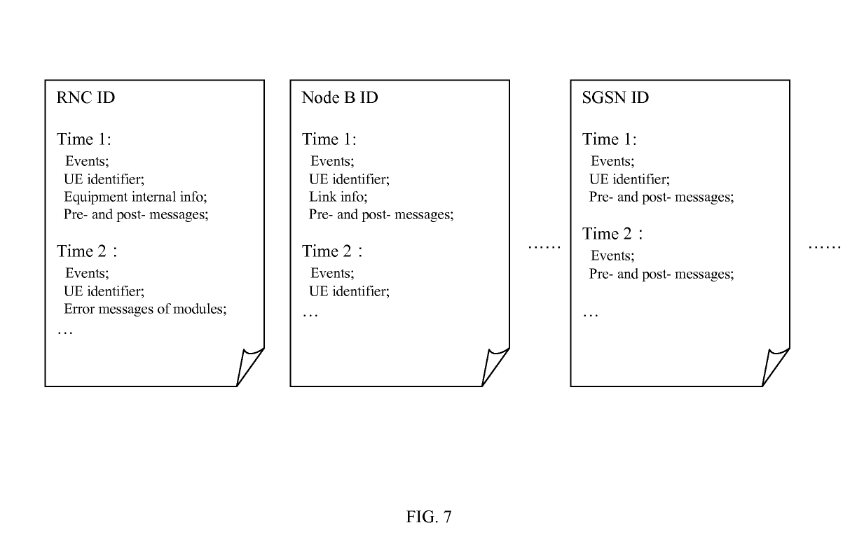

The data server may further store data that is related to calling and performance and provided by other network entities, such as a Regional Node Center (RNC), a Node B, a Service GPRS Support Node (SGSN), and a Gateway GPRS Support Node (GGSN). Such data may be statistical data, or records based on time and/or discreet events, which may include records of pre- and post-messages when certain pre-defined network events or equipment events occur. For instance, such data may include customizable events, such as call drop, handover failure, connection release, board problems, re-start, or other abnormal events, etc.; information related to network events or mobile phone events, such as the events described in the embodiments of the present invention, including mobile phone IDs, board IDs, link IDs, and error information of equipment's functional components, etc.; or pre- and post-messages of equipments around a network or mobile phone event. FIG. 7 illustrates an embodiment of data provided by network elements and stored on a data server.

The system in the embodiments of the present invention may not only provide automatic network performance monitoring and management, but also provide comprehensive processing of data provided from both mobile phone side and network side. In combination of an “expert system” available for problem analysis, the system may provide fast and before-hand problem analysis.

Processing of the data stored on a data server may include correlation of data on network side and mobile phone side; comprehensive analysis of data on the data server, and generation of processing results, which may be displayed or reported, and used in problem identification and network performance improvement.

Correlation of data on network side and mobile phone side may be based on events occurring on the mobile phone side. For each event on mobile phone side, the system in the embodiments of the present invention may search for data, obtained at about the same time of the event, by network elements on network side. For instance, the system may correlate information related to the same calling initiated by a mobile phone with information stored in related network elements; and input the correlated information into an “expert system” for analysis, forming an initial optimization plan.

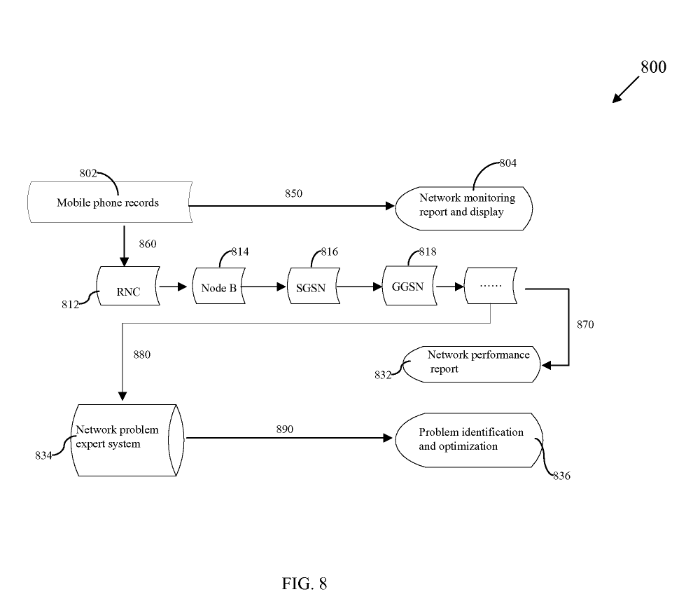

FIG. 8 illustrates one embodiment of a block diagram 800 for processing information stored in a data server using correlation of data on mobile phone side and network side. First in step 850, separate reports and displays 804 related to network monitoring may be generated using data 802 collected on mobile phone side. Events on mobile phone side may be correlated with information that is produced at the same time of the events and provided by other network elements, such as RNC 812, Node B 814, SGSN 816, GGSN 818, etc., using mobile phone IDs and time information in step 860. The correlated information may be used to generate network quality reports or information tables 832 in step 870; or may be input into an “expert system” 834 in step 880, which may produce in step 890 possible problem identification and optimization opinions 836.

The data obtained on both the network and the mobile phone sides may be processed to produce the following results:

1. Geographical display on a map of information related to a mobile phone user, such as movement of users, service procedures, location information, wireless signal information, and abnormal events, etc.

2. Statistical reports, graphical display, network KPI statistics, and abnormality reports (e.g., “holes” in network coverage, poor coverage, severe interference areas, and pilot pollution, etc.) of wireless signal coverage and quality information, for a whole network or different cells during different period of time.

3. Graphical display, statistical reports, and abnormality reports of end-to-end performance indicators and QoE of various services, for a whole network or different cells, and during different period of time or for a whole day. The results may provide success rates, time delays, jitters, number and time of buffering, response time, and average rates, etc. of various services (e.g., voice, video, MMS, web services, and stream medium, etc.), and MOS for these services, in order to timely discover performance problems of services, and improve user satisfaction of services.

4. Analysis (including graphical display, statistical reports and abnormality reports) and statistics of parameters, such as success rates, time delays, and average number of attempts, etc. of non-connection procedures, such as cell search, cell selection and re-selection, paging, random access, and inter-RAT handover, etc, for a whole network or different cells, and during different period of time or for a whole day.

5. The processing may provide comprehensive analysis and definition of problems by correlating pre- and post-messages around key events (mainly include various failures and anomalies) on mobile phone side and CHRs on network side. In this way, failures caused by mobile phones are separated. Internal anomalies of a mobile phone may include network disconnection, power failure or battery exhaust, system halted, abnormal power control, start or end of active services, and failure of software applications, etc.

6. Statistics of usage of mobile phone services for a whole network or different cells, which may include number of usage of a service, average usage time, statistics of traffic volume. This may help understand usage trend of various services.

The processing results may be displayed according to operator's configuration. The display may include data from all mobile phones participating network performance monitoring and management, or data from a certain mobile phone, a particular group of mobile phones, or mobile phones within a particular area, etc. Data within certain period of time and areas may be replayed, and the time and areas are controllable. Data and events to be displayed may also be configurable, and customized information table may be generated.

Compared with a conventional automatic driving test system, the system in the embodiments of the present invention may provide more flexible deployment capabilities and more evenly-distributed testing samples, and may better represent real QoE of a network and services thereof. Furthermore, the system may automatically and actively identify network problems, provide comprehensive end-to-end analysis and optimization of networks, improving efficiency for optimizing networks and reducing cost for operating and maintaining networks.

H. System Implementation

In application of the present invention, one embodiment selects friendly users in a mobile communication network as needed, and the users may have mobile phones configured to have one or more of the extended monitoring functions, as described previously. The higher the density at which the mobile phones are distributed, the more efficient the network monitoring and management. Alternatively, engineers may carry one or more of such mobile phones for testing purposes.

An embodiment of implementing the system of the present invention to perform network performance monitoring and management is described below.

1. Operators may provide hardware and software on network side of a mobile communication network according to what has been described previously, and arrange mobile phones with extended monitoring functions described in the present invention.

2. The mobile phones arranged may be registered by the operator.

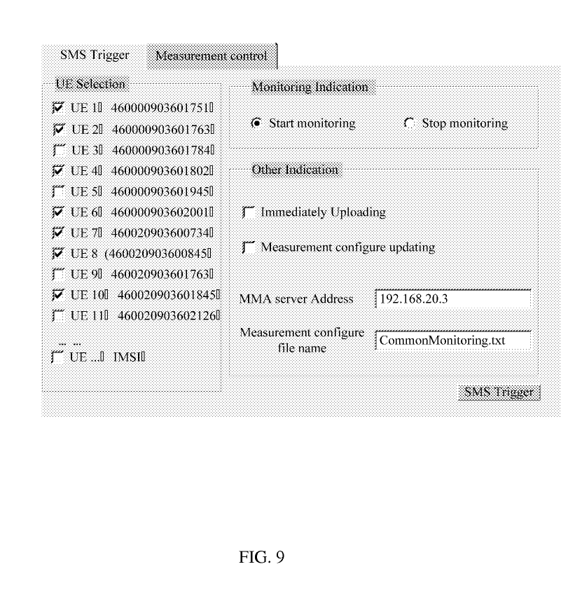

3. The system may select one or more of the mobile phones from a configuration user interface of an MMA on network side, according to geographic information of the mobile phones, and generate triggering short messages. The mobile phones selected may be triggered to perform the extended monitoring functions. FIG. 9 illustrates an embodiment of a user interface of an MMA on network side, where mobile phones may be selected and triggered to start monitoring.

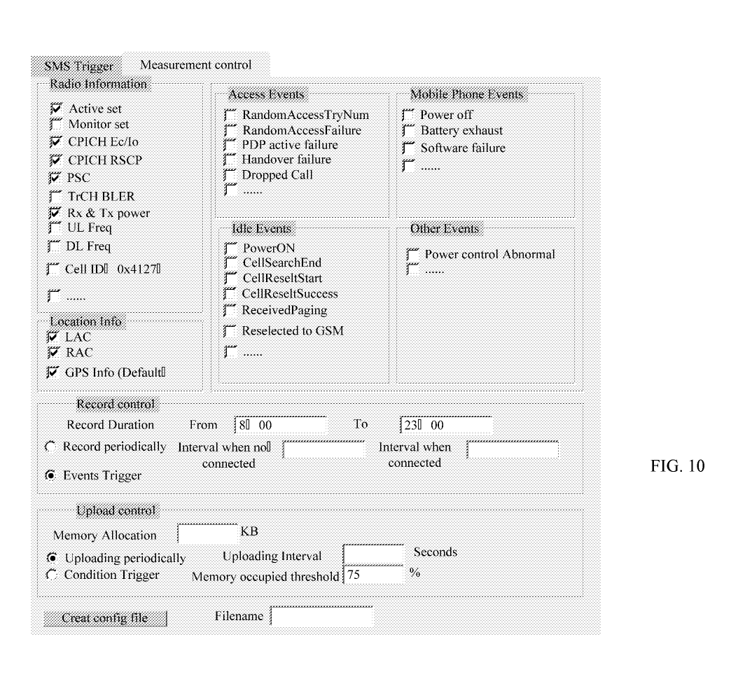

4. The system may also define various information items to be obtained by the selected mobile phones, and uploading methods and conditions, using the configuration user interface of the MMA, as illustrated in FIG. 10, and generate a measurement configuration file.

5. The system may design various test cases utilizing step 3 and step 4 above. For example, testing users may be divided into groups for different testing purposes. Different groups may act differently according to different measurement configuration file, and users in the same group may act according the same configuration file.

6. The system may send short messages to trigger mobile phones to start monitoring.

7. A mobile phone may respond to a short message received, interpret the short message, download a measurement configuration file and interpret the measurement configuration file, and start monitoring accordingly.

8. A mobile phone may update the measurement configuration file or terminate the monitoring according to other short messages received consequently.

9. A mobile phone may upload the monitoring information once a particular uploading requirement is met.

10. The monitoring information from the mobile phones is received on network side, and processed accordingly to generate reports related to network performance and problems. The system may analyze the received data, identify the problems, and perform correspondent adjustment or optimization to the network. The system may continue to monitoring performance of the adjusted or optimized network.

A mobile phone with one or more of the monitoring functions described in the present invention may be used as an actual commercial mobile phone, as a testing mobile phone, or as a fixed wireless terminal, to form alternative embodiments of the present invention. Engineers may carry mobile phones with the monitoring functions of the present invention, instead of the conventional driving test tools, to perform manual tests.

Monitoring information of a mobile phone may vary as needed, formulating different testing schemes. For example, a test may be performed only for monitoring quality of services, or only for monitoring wireless coverage. A network may control monitoring of a mobile phone by only sending short messages or multimedia messages to the mobile phone, instead of sending a combination of short messages and a measurement configuration file. The short messages or the multimedia messages may include needed monitoring control information, and have a self-defined format. Mobile phones receiving the shorts messages or multimedia messages should be able to interpret the messages. Data uploading or downloading may be performed by ftp or Web, or other equivalents. The data processing results may not be limited to those described in the present invention.

Network operators may select friendly mobile phone users and distribute, evenly or unevenly on purpose, the mobile phones in testing areas, defining various testing cases, and providing monitoring and management of network performance with different emphasis. As more and more mobile phones are provided with the monitoring functions and network bandwidth increases quickly, it is expected that in the age of 4G, every mobile phone user may become a monitoring point, and network problems may be easily detected. In this case, the system for network performance management and optimization will become completely automatic, covering all areas and being pre-optimized.

The system of the present invention provides network monitoring and management using actual users, and may automatically and continuously obtain network and service data, reducing cost for network maintenance and optimization. Operators may configure different monitoring schemes in different areas at the same time. Deployment of and testing by the system in the present invention are less restricted by natural conditions and thus more flexible and convenient, reducing overall cost.

The system also provides broader testing areas, and performs tests conveniently on trunk roads, and within offices and residence areas as well. Testing points of the system are distributed more evenly, and testing data is generated from actual mobile phone users, reflecting more closely actual network situations. With the system in the present invention, engineers may be focused more on analyzing and solving problems, instead of performing driving tests.

The system also automatically detects problems that a network may have on signal coverage, signal quality, network performance and quality of services, etc. The system in the present invention may also provide measurement of quality of services, including end-to-end performance indicators and experience of services, helping detect problems in advance, and improving user satisfaction of services.

In addition, the system monitors and optimizes procedures of mobile phones in idle mode, expanding range of performance management; and record abnormal events on mobile phone side, isolating factors of mobile phones during problem analysis. Furthermore, information of pre- and post-messages around key events, wireless signal information, GPS location information, and physiognomy and topography on the map, etc. on mobile phone side can be correlated with CHR and other information on network side, for providing comprehensive analysis, and improving problem analysis and pinpointing capabilities. With the system in the present invention, operators are able to detect and solve the network and service problems earlier, avoiding users' complaint.

The previous description of the disclosed embodiments is provided to enable those skilled in the art to make or use the present invention. Various modifications to these embodiments will be readily apparent to those skilled in the art and generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A system for automatically monitoring and managing network performance, comprising:
a mobile phone, adapted to have a monitoring function for providing monitoring information and communications regarding monitoring and management of network performance; and
a mobile communication network, providing mobile communication services to the mobile phone, comprising:
a Mobile Measurement Agent (MMA), adapted to control performing of the monitoring function of the mobile phone, and to communicate with the mobile phone;
a data server, adapted to store information comprising the monitoring information; and
a component for processing the information stored in the data server, wherein a processing result of the information is used in performance monitoring and management of the mobile communication network.

2. The system of claim 1, wherein the mobile phone provides Global Positioning System (GPS) information.

3. The system of claim 1, wherein the mobile phone performs the monitoring function upon satisfaction of a triggering condition or on a periodic base.

4. The system of claim 3, wherein the condition comprises occurrence of an event of the mobile phone.

5. The system of claim 1, wherein the monitoring information comprises wireless signal information, network information or location information.

6. The system of claim 1, wherein the monitoring information comprises strength and quality of a receiving signal, Signal-Interference Ratio (SIR), Transport Channel Block Error Rate (TRCH BLER), transmitted and received power, CELL ID, frequency, User Registration Area (URA) ID, or Global Positioning System (GPS) information.

7. The system of claim 1, wherein the monitoring information comprises a record of a procedure, an event, or a pre- and post-message around an event of the mobile phone.

8. The system of claim 7, wherein the mobile phone is in idle mode.

9. The system of claim 7, wherein the procedure or event comprises power-on, end of cell search, start and end of cell re-selection, paging receiving time and response time, starting and ending time of random access, number of attempts of random access, or inter-RAT (Radio Access Technology) handover.

10. The system of claim 7, wherein the procedure or event comprises access failure, PDP activation failure, call drops, handover failures, or link release.

11. The system of claim 7, wherein the procedure or event comprises lost network connection, no signal, battery exhaust, power-off, system halted for software problems, poor coverage, strong interference or poor speech quality.

12. The system of claim 7, wherein the event is user-definable or configurable.

13. The system of claim 1, wherein the monitoring information comprises information of Quality of Service (QoS) or user's Experience of Service (EoS) of the mobile phone.

14. The system of claim 13, wherein the user's Experience of Service (EoS) is measured utilizing Mean Opinion Score (MOS).

15. The system of claim 1, wherein the monitoring information comprises a record of an event of the mobile phone that is unavailable to the mobile communication network.

16. The system of claim 1, wherein the mobile phone is adapted to upload the monitoring information to the MMA server.

17. The system of claim 16, wherein the mobile phone initiates uploading of the monitoring information to the MMA server on conditions or periodically.

18. The system of claim 1, wherein the mobile phone is adapted to compress the monitoring information.

19. The system of claim 1, wherein the mobile phone is adapted to download data from the mobile communication network.

20. The system of claim 1, wherein the mobile communication network comprises a Code Division Multiplex Access (CDMA) 2000 network, a Universal Mobile Telecommunication System (UMTS) network , a WiMAX network, an Enhanced Data rates for GSM Evolution (EDGE) network, or a 4G network.

21. The system of claim 1, wherein the MMA server has knowledge of the mobile phone.

22. The system of claim 21, wherein the knowledge comprises mobile phone ID of the mobile phone.

23. The system of claim 1, wherein the MMA server is provided with an IP address.

24. The system of claim 1, wherein the MMA server is accessible by the mobile phone.

25. The system of claim 1, wherein the MMA server controls the performing of the monitoring function on the mobile phone via a short message, a Multimedia Message (MMS), a measurement configuration file, or combination thereof.

26. The system of claim 25, wherein the measurement configuration file is provided by the MMA server.

27. The system of claim 25, wherein the measurement configuration file is configurable.

28. The system of claim 25, wherein the mobile phone is adapted to download the measurement configuration file from the MMA server.

29. The system of claim 1, wherein the MMA server is adapted to authenticate the mobile phone if the mobile phone wants to access the MMA server.

30. The system of claim 1, wherein the MMA server is adapted to support data uploading or downloading for the mobile phone.

31. The system of claim 30, wherein the MMA server is adapted to be an FTP server, an HTTP server, or a Web server.

32. The system of claim 1, wherein the MMA server is adapted to decompress the monitoring information compressed and provided by the mobile phone.

33. The system of claim 1, wherein the data server is adapted to store information obtained from a network element of the mobile communication network.

34. The system of claim 33, wherein the network element comprises a Regional Node Center (RNC), a Node B, a Service GPRS Support Node (SGSN), or a Gateway GPRS Support Node (GGSN).

35. The system of claim 33, wherein the information comprises a record of a pre- and post-message around an event of the mobile communication network, or information related to the occurrence of an event of the mobile communication network or the mobile phone comprising a mobile phone ID, a board ID, a link ID, or error information of an equipment's functional component, wherein the event comprises call drop, handover failure, connection release, board problems, re-start, or an abnormal event.

36. The system of claim 1, wherein processing of the information stored in the data server comprises correlating the monitoring information obtained from the mobile phone with information obtained from a network element of the mobile communication network.

37. The system of claim 36, wherein the correlating is performed utilizing event information of the mobile phone, the mobile phone ID, or time information.

38. The system of claim 1, wherein the component for processing information stored in the data server processes the information using a method comprising the steps of:
generating a network monitoring reports using the monitoring information obtained by the mobile phone;
correlating information provided by a network element of the mobile communication network with the monitoring information to generate a network performance report; and
inputting the correlated results into an expert system to identify problems and generate an optimization plan.

39. The system of claim 1, wherein the data server further comprises a network problem expert system.

40. The system of claim 1, wherein the processing result is provided for the whole mobile communication network, or for a cell.

41. The system of claim 1, wherein the processing result is provided according to different time period, or for a day.

42. The system of claim 1, wherein the processing result comprises a statistical report, a graphical display, a network Key Performance Indicator (KPI) statistical report, or an abnormality report.

43. The system of claim 42, wherein the abnormality report comprises information related to holes in network coverage, poor network coverage, severe interference areas, or pilot pollution.

44. The system of claim 1, wherein the processing result comprises a geographical display of information related to the mobile phone, or services provided to the mobile phone.

45. The system of claim 1, wherein the processing result comprises information related to wireless signal coverage or wireless signal quality.

46. The system of claim 1, wherein the processing result comprises information related to end-to-end performance indicators or quality of experience of services.

47. The system of claim 46, wherein the information comprises success rate, jitter, number of buffering, response time, average rate, or Mean Opinion Score (MOS).

48. The system of claim 46, wherein the services comprise audio, video, Multimedia Message, Web or stream medium services.

49. The system of claim 1, wherein the processing results comprise information related to a non-connection procedure.

50. The system of claim 49, wherein the information comprises success rate, time delay or average attempt number of processes comprising cell search, cell selection and re-selection, paging, random access, or inter-RAT handover.

51. The system of claim 1, wherein the processing result comprises statistical information related to usage of a mobile communication service.

52. The system of claim 51, wherein the statistical information comprises number of usage of a service, average usage time, or statistics of traffic volume.

53. The system of claim 1, wherein the processing result is displayable and the display of the processing result is configurable.

54. The system of claim 1, wherein services used by the mobile phone concerning the monitoring and management of network performance of the mobile communication network is not charged.

55. A method for automatically monitoring and managing network performance, comprising the steps of:
providing a plurality of mobile phones in a mobile communication network, each adapted to have a monitoring function for providing monitoring information and communications with the mobile communication network regarding monitoring and management of network performance, wherein the monitoring function is performed under the control of the mobile communication network;
obtaining monitoring information by at least one of the plurality of mobile phones;
processing the obtained monitoring information in combination with other related information obtained on the mobile communication network; and
utilizing a processing result for improving the mobile communication network performance if needed.

56. The method of claim 55, wherein the monitoring information comprises wireless signal information, network information, location information, a record of a procedure or an event of the mobile phone, a pre- and post-message around an event of the mobile phone, Quality of Service (QoS), or user's Experience of Service (EoS) of the mobile phone.

57. The method of claim 55, wherein the mobile communication network controls the performing of the monitoring function via a short message, a multimedia message, a measurement configuration file, or combination thereof.

58. The method of claim 55, wherein the plurality of mobile phones are adapted to upload to or download from the mobile communication network.

59. A system for automatically monitoring and managing network performance, comprises:
a commercially used mobile phone, adapted to have a monitoring function for providing monitoring information and communications regarding monitoring and management of network performance, and to provide Global Positioning System (GPS) information; and
a mobile communication network, providing mobile communication services to the mobile phone, comprising:
a Mobile Measurement Agent (MMA), adapted to control performing of the monitoring function of the mobile phone using a short message, a multimedia message, a measurement configuration file or combination thereof, and to support data uploading and downloading by the mobile phone;
a data server, adapted to store information comprising the monitoring information and information obtained from a network element of the mobile communication network; and
a component for processing the information stored in the data server, wherein a processing result of the information is used in performance monitoring and management of the mobile communication network;
wherein the monitoring information comprises wireless signal information, network information, location information, a record of a procedure or an event of the mobile phone, a pre- and post-message around an event of the mobile phone, Quality of Service (QoS) or user's Experience of Service (EoS) of the mobile phone, or an event of the mobile phone that is unavailable to the mobile communication network;
wherein the mobile phone is adapted to upload the monitoring information to the MMA server; and
wherein the processing result comprises a statistical report, a graphical display, a network Key Performance Indicator statistical report, or an abnormality report of information related to use of the mobile phone, services used by the mobile phone, or user's experience of the services.

60. The system of claim 59, wherein the mobile communication network comprises a Code Division Multiplex Access (CDMA) 2000 network, a Universal Mobile Telecommunication System (UMTS) network, a WiMAX network, an Enhanced Data rates for GSM Evolution (EDGE) network, or a 4G network.
